(19) United States
(12) Patent Application Publication
(10) Pub. No.: US 2017/0292779 A1
(43) Pub. Date: Oct. 12, 2017

(54) REFRIGERATOR AND LIGHTING ASSEMBLY FOR A REFRIGERATOR

(71) Applicant: Dongbu Daewoo Electronics Corporation, Seoul (KR)

(72) Inventor: Wang Goo LEE, Seoul (KR)

(21) Appl. No.: 15/365,490

(22) Filed: Nov. 30, 2016

(30) Foreign Application Priority Data
Apr. 12, 2016 (KR) 10-2016-0045090

(51) Int. Cl. F25D 27/00; F25D 25/00; A23B 7/015; F25D 11/02

(52) U.S. Cl. CPC F25D 27/00; F25D 11/02; F25D 25/005; A23B 7/015; A23V 2002/00

(57) ABSTRACT

A demand exists for a method or device capable of improving the length that produce can be kept fresh within a produce compartment of a refrigerator. The present disclosure provides a refrigerator including a cold air generation unit configured to generate cold air required within the refrigerator main body, a produce storage unit configured to accommodate a produce box, and a lighting assembly configured to illuminate produce stored within the produce box. The lighting assembly includes a light emitting body including an LED illuminator configured to irradiate LED light for enhancing the freshness of the produce. A diffusion plate disposed on an inner wall of the produce box is used to diffuse the light into the produce box.

### CROSS-REFERENCE TO RELATED APPLICATIONS

This application is based on and claims priority from Korean Patent Application No. 10-2016-0045090, filed on Apr. 12, 2016, the disclosure of which is incorporated herein in its entirety by reference.

### TECHNICAL FIELD

The present disclosure generally relates to the field of refrigerators, and more specifically, to lighting assemblies for refrigerators.

### BACKGROUND

A refrigerator is an apparatus used for storing food at a low temperature and may be used to store food in a frozen state or a refrigerated state using separate compartments.

The interior of a refrigerator is typically cooled by a continuous supply of cold air. The cold air is generated by a refrigerant using a cycle consisting of compression, condensation, expansion and evaporation (e.g., a thermodynamic or “heat exchange” cycle). The cold air supplied to the refrigerator is provided to the interior of the refrigerator by convection and is used to store food at a desired temperature within the refrigerator.

Refrigerators may include a main body having a rectangular shape and an opening on a front surface thereof. A refrigeration chamber and a freezer chamber may be disposed within the main body. A refrigeration chamber door and a freezer chamber door are used for selectively opening and closing the open portions of the front surface of the main body. Drawers, shelves, storage compartments, and the like may be provided in the internal storage spaces of the refrigerator for optimally storing different types of food.

Top-mount refrigerators having a freezer chamber positioned at an upper end of the refrigerator and a refrigeration chamber positioned at a lower end of the refrigerator are a common type of refrigerator. In recent years, however, bottom-freeze refrigerators having a freezer chamber positioned at a lower end of the refrigerator have become popular due to enhanced user convenience.

For conventional refrigerators, even when the internal temperature and humidity of a produce compartment are kept constant, it may be difficult to maintain the freshness of produce (e.g., fruit, vegetables, herbs, etc.) stored in the produce compartment for a long period of time. The produce may quickly wilt or decompose while stored in this way. Thus, a demand exists for a method or device capable of storing produce in a produce compartment of a refrigerator to better preserve the freshness and/or improve the texture (e.g., “mouth-feel”) of the produce.

### SUMMARY

Embodiments of the present disclosure provide a refrigerator and a lighting assembly for a refrigerator capable of storing produce in a fresh state within a produce compartment.

According to one embodiment, a refrigerator is disclosed. The refrigerator includes a refrigerator main body, a cold air generation unit disposed within the refrigerator main body and configured to generate cold air within the refrigerator main body, a produce storage unit disposed within the refrigerator main body configured to accommodate a removable produce box, and a lighting assembly configured to illuminate produce stored within the produce box. The lighting assembly includes a light emitting body including a light-emitting diode (LED) configured to irradiate the produce with LED light to preserve freshness of the produce, and a diffusion plate disposed on an inner wall of the produce box and configured to uniformly diffuse the LED light into an internal space of the produce box.

According to another embodiment, a refrigerator is disclosed. The refrigerator includes a refrigerator main body, a cold air generation unit configured to generate cold air within the refrigerator main body, a produce storage unit configured to accommodate a removable produce box, and a lighting assembly configured to illuminate produce stored within the produce box. The lighting assembly includes a light emitting body configured to irradiate the produce with light, a mounting bracket configured to mount the light emitting body to the produce storage unit, and a diffusion plate disposed on an inner wall of the produce box and configured to diffuse the light into the produce box. The mounting bracket includes a mounting plate disposed on a guide shelf of the produce storage unit and having a hole through which the light is transmitted, and a plurality of support pieces protruding from the mounting plate to support the light emitting body.

According to another embodiment, a lighting assembly for a refrigerator is disclosed. The lighting assembly includes a light emitting body configured to irradiate light, a mounting bracket disposed in a produce storage unit of the refrigerator, and coupled to the light emitting body, and a diffusion plate disposed on an inner wall of a removable produce box of the produce storage unit and configured to diffuse the light into the produce box.

### BRIEF DESCRIPTION OF THE DRAWINGS

FIG. 1 is a side sectional view illustrating an exemplary refrigerator according to one embodiment of the present disclosure.

FIG. 2 is a side sectional view illustrating an exemplary lighting assembly of a refrigerator according to one embodiment of the present disclosure.

FIG. 3 is a partially cutaway perspective view illustrating an exemplary lighting assembly of a refrigerator according to one embodiment of the present disclosure.

FIG. 4 is a perspective view illustrating a coupling state between an exemplary light emitting body and an exemplary mounting bracket of a refrigerator according to one embodiment of the present disclosure.

FIG. 5 is a partially cutaway perspective view illustrating an exemplary lighting assembly of a refrigerator according to one embodiment of the present disclosure.

FIG. 6 is a side sectional view illustrating an exemplary lighting assembly of a refrigerator according to embodiments of the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

One or more exemplary embodiments of the present disclosure will be described more fully hereinafter with reference to the accompanying drawings, in which one or more exemplary embodiments of the disclosure can be easily determined by those skilled in the art. As those skilled in the art will realize, the described exemplary embodiments may be modified in various different ways, all without departing from the spirit or scope of the present disclosure, which is not limited to the exemplary embodiments described herein.

It is noted that the drawings are schematic and are not necessarily dimensionally illustrated. Relative sizes and proportions of parts in the drawings may be exaggerated or reduced in size, and a predetermined size is merely exemplary and not limiting. The same reference numerals designate the same structures, elements, or parts illustrated in two or more drawings in order to exhibit similar characteristics.

The exemplary embodiments of the present disclosure illustrate ideal exemplary embodiments of the present disclosure in more detail. As a result, various modifications of the drawings are expected. Accordingly, the exemplary embodiments are not limited to a specific form of the illustrated region, and for example, may include modifications in form due to manufacturing.

The configuration and operation according embodiments of the present disclosure will now be described in detail with reference to the accompanying drawings.

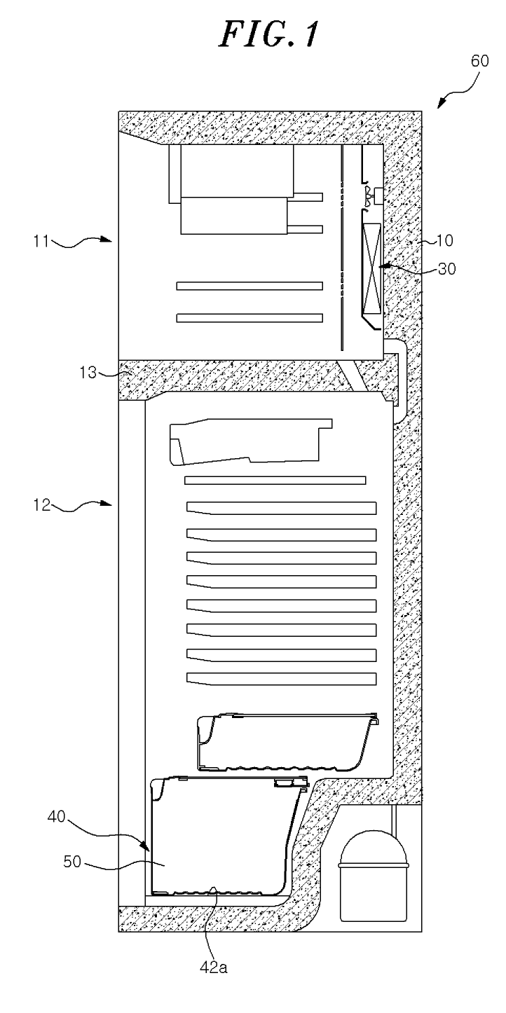

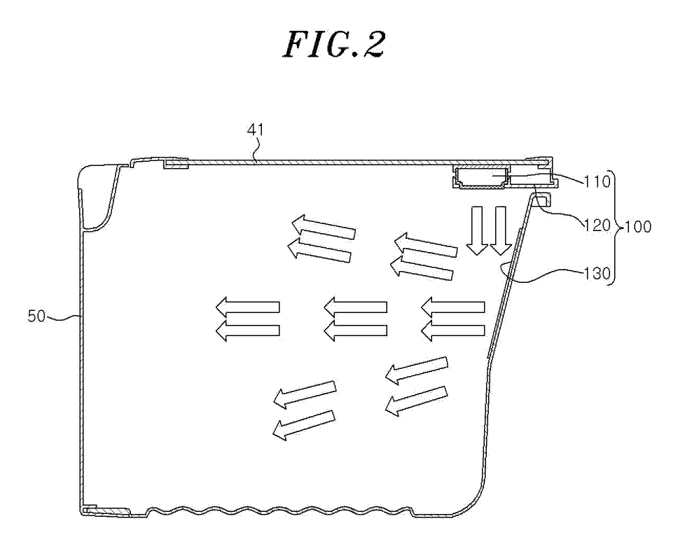

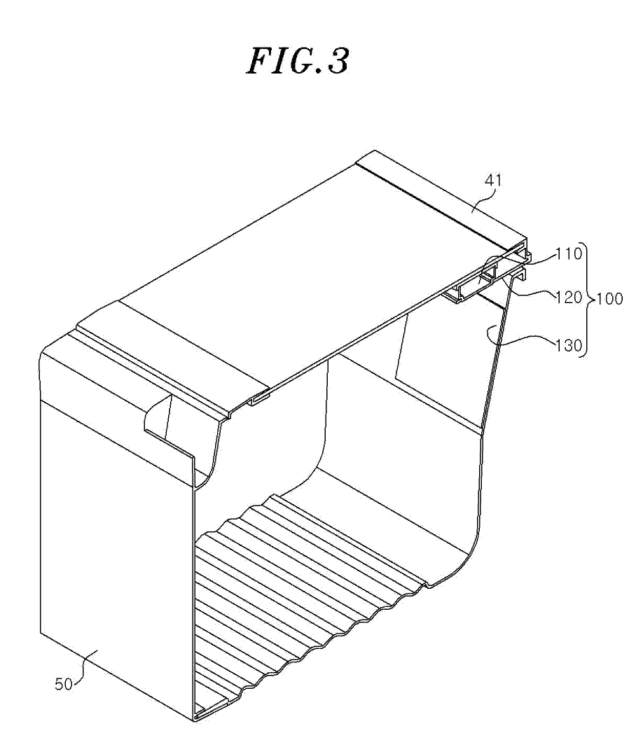

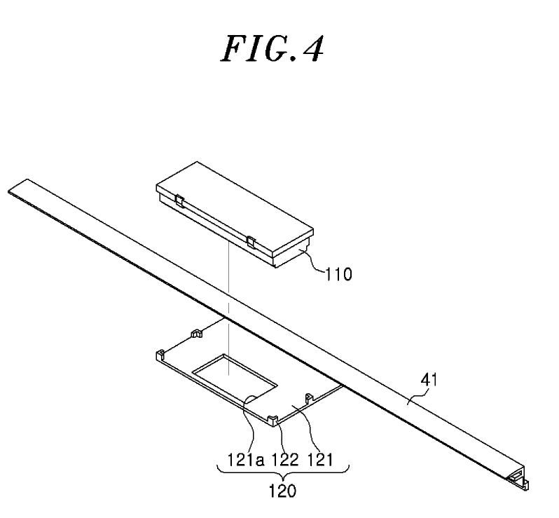

FIG. 1 is a side sectional view illustrating an exemplary refrigerator according to one embodiment of the present disclosure. FIG. 2 is a side sectional view illustrating an exemplary lighting assembly of a refrigerator according to one embodiment of the present disclosure. FIG. 3 is a partially cutaway perspective view illustrating an exemplary lighting assembly of a refrigerator according to one embodiment of the present disclosure. FIG. 4 is a perspective view illustrating a coupling state between an exemplary light emitting body and an exemplary mounting bracket of a refrigerator according to one embodiment of the present disclosure.

Referring to FIGS. 1 to 4, according to one embodiment of the present disclosure, a refrigerator 60 is capable of uniformly irradiating LED light on produce contained in a produce box 50 to maintain the freshness of produce for a relatively long period of time. The refrigerator 60 is a top-mount-type refrigerator in which a freezer chamber 11 is positioned above a refrigeration chamber 12. However, the present disclosure is not limited thereto and may be applicable to different types of refrigerators.

The refrigerator 60 may include a refrigerator main body 10 which forms an outer shell of the refrigerator 60, a door configured to selectively open and close an internal space of the refrigerator main body 10, a cold air generation unit 30 configured to generate cold air, a produce storage unit 40 configured to accommodate a produce box 50, and a lighting assembly 100 configured to diffuse and supply LED light to produce stored in the produce box 50.

Specifically, the refrigerator main body 10 may be divided into a freezer chamber 11 and a refrigeration chamber 12 by a barrier 13. For example, the freezer chamber 11 may be provided in an upper portion of the refrigerator main body 10. The refrigeration chamber 12 may be provided in a lower portion of the refrigerator main body 10. The freezer chamber 11 and the refrigeration chamber 12 may be opened and closed using doors.

The doors (not shown) may include a freezer chamber door and a refrigeration chamber door. The freezer chamber door may seal the freezer chamber 11 by closing an upper front portion of the refrigerator main body 10. The refrigeration chamber door may seal the refrigeration chamber 12 by closing a lower front portion of the refrigerator main body 10.

The cold air generation unit 30 generates cold air for cooling the freezer chamber 11 and the refrigeration chamber 12. For this purpose, the cold air generation unit 30 may include one or more freezing cycle devices for generating cold air. The freezing cycle devices may include, for example, a compressor, a condenser, an expansion valve and an evaporator, which together may be used to provide a freezing cycle. A heat exchange process using a refrigerant may be performed by implementing a freezing cycle consisting of compression, condensation, expansion and evaporation using the compressor, the condenser, the expansion valve and the evaporator, respectively. The air within the refrigerator 60 may be cooled by exchanging heat with the refrigerant.

The produce storage unit 40 may include a guide shelf 41 installed in the refrigerator main body 10 at a lower portion of the refrigeration chamber 12, and an accommodation space, where the produce box 50 can be positioned within the accommodation space while being covered by the guide shelf 41.

According to some embodiments, the bottom surface of the accommodation space includes a slanted surface 42a inclined downward in the direction that the produce box 50 is inserted (e.g., slanted down toward the back side of the refrigerator). In this way, a user can insert the produce box 50 into the accommodation space of the produce storage unit 40 with a relatively small amount of force. For example, when a user inserts the produce box 50 into the accommodation space of the produce storage unit 40, the weight of the produce box 50 is added to the user's pushing force. This enables a user to quickly and easily insert the produce box 50 into the accommodation space using a relatively small amount of force.

The lighting assembly 100 may include a light emitting body 110, a mounting bracket 120 and a diffusion plate 130. The lighting assembly 100 may diffuse and provide light to produce stored within the produce box 50.

The light emitting body 110 may include an LED illuminator for irradiating produce with LED light. The LED illuminator may adjust the wavelength of LED light emitted to optimally maintain the freshness of produce.

For example, substantially red LED light emitted by the light emitting body 110 is capable of promoting the growth of produce. Substantially blue LED light emitted by the light emitting body 110 is capable of hardening the tissue of produce, thereby giving a crisp texture or “mouth feel” to produce. The produce irradiated by LED light in this way may have a fresh and crisp taste compared to produce irradiated by typical illumination light, or compared to produce not irradiated by light.

The light emitting body 110 may include different kinds of illuminators capable of generating light used to enhance the freshness of produce stored within the produce box 50.

The mounting bracket 120 may be provided in the produce storage unit 40 for mounting the light emitting body 110. For example, the mounting bracket 120 may include a mounting plate 121 installed on the guide shelf 41 of the produce storage unit 40 and a plurality of support pieces 122 protruding from the mounting plate 121 to support the light emitting body 110 (e.g., to support an edge of the light emitting body 110).

In the present embodiment, the mounting plate 121 is disposed at the rear side of the guide shelf 41. The mounting plate 121 includes a through-hole 121a through which light is transmitted. According to some embodiments, the support pieces 122 include four support pieces having an L-shaped cross-section for supporting the light emitting body 110. However, the installation position of the mounting plate 121, the shape of the through-hole 121a and the number and shape of the support pieces 122 are not limited to those specified.

The diffusion plate 130 uniformly diffuses LED light into the produce box 50. The diffusion plate 130 may be positioned on an inner wall of the produce box 50, for example, on the inner wall of the produce box 50 below the light emitting body 110.

According to some embodiments, the diffusion plate 130 may be mounted to a case (not shown) positioned along the inner wall of the produce box 50, where the case may be formed using a dual injection method. For example, the diffusion plate 130 may be easily and stably mounted to the case of the inner wall of the produce box 50 using screws or a snap-fit method.

The diffusion plate 130 includes material capable of effectively diffusing LED light. For example, according to some embodiments, the diffusion plate 130 includes highly reflective aluminum. The diffusion plate 130 may uniformly diffuse the LED light irradiated from the light emitting body 110 and direct the LED light toward the produce. Thus, the produce stored within the produce box 50 may be uniformly irradiated by the LED light regardless of where the light emitting body 110 is positioned to thereby maintain optimal freshness of the produce.

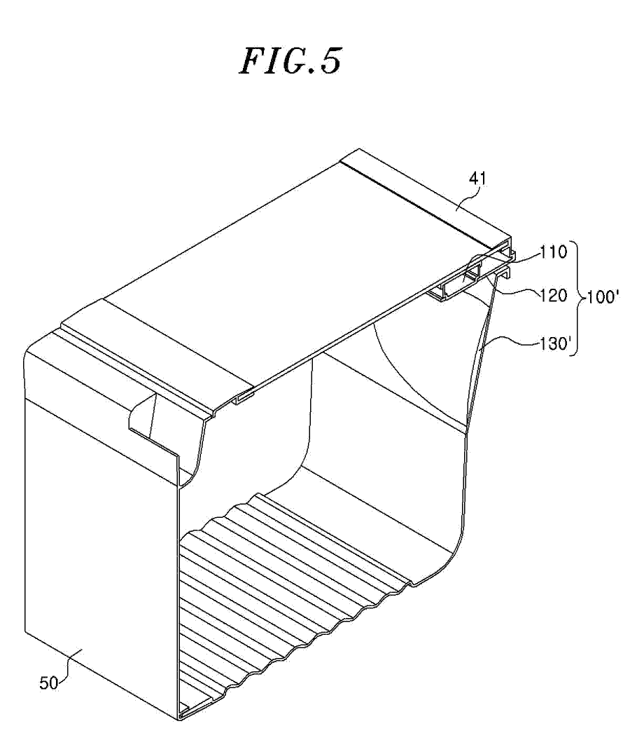

FIG. 5 is a partially cutaway perspective view illustrating an exemplary lighting assembly 100′ of a refrigerator according to embodiments of the present disclosure.

As shown in FIG. 5, the lighting assembly 100′ includes a diffusion plate 130′, which may be disposed on an inner wall of the produce box 50 and may have a surface which is curved (e.g., a convex shape). In this case, the curved surface may have a curvature such that the curved surface can receive LED light from the light emitting body 110 and can diffuse the LED light into the internal space of the produce box 50.

The diffusion plate 130′ having a convex shape directed at the internal space of the produce box 50 can effectively diffuse and reflect the light of the light emitting body 110 toward produce stored in the produce box 50.

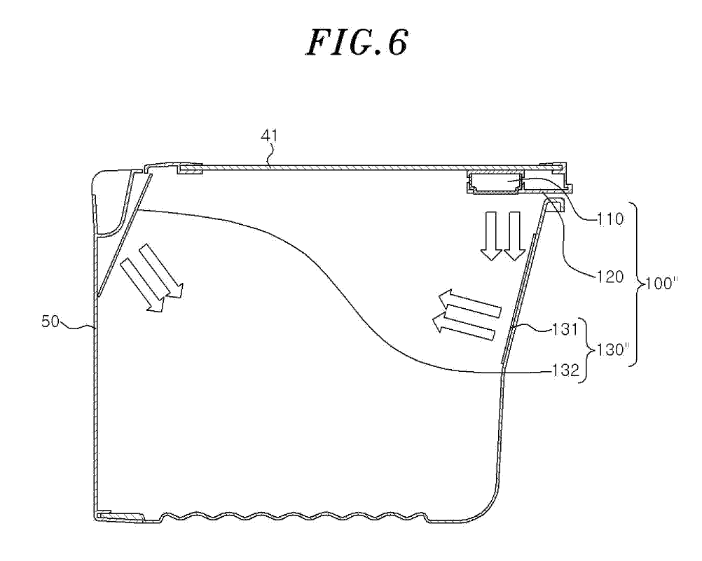

FIG. 6 is a side sectional view illustrating an exemplary lighting assembly 100″ of a refrigerator according to embodiments of the present disclosure. As shown in FIG. 6, the lighting assembly 100″ includes a diffusion plate 103″, which may include a first reflection plate 131 mounted to a rear inner wall of the produce box 50 below the light emitting body 110, and a second reflection plate 132 mounted to a front inner wall of the produce box 50.

The first reflection plate 131 is obliquely positioned at a predetermined angle on the rear inner wall of the produce box 50 to face the front upper side of the produce box 50. The first reflection plate 131 reflects the LED light received from the light emitting body 110 toward the front upper side of the produce box 50. The second reflection plate 132 is obliquely positioned at a predetermined angle on the front inner wall of the produce box 50 to face the rear lower side of the produce box 50. The second reflection plate 132 reflects the LED light received from the first reflection plate 131 toward the rear lower side of the produce box 50.

Accordingly, if the light emitting body 110 is installed at the rear of the produce box 50, part of the LED light of the light emitting body 110 may directly irradiate the produce positioned at a rear portion of the produce box 50. The remainder of the LED light may be reflected by the first reflection plate 131 toward the second reflection plate 132, and the LED light irradiates the produce positioned at a front portion of the produce box 50.

As a result, the produce stored within the produce box 50 may be uniformly irradiated by the LED light from the light emitting body 110 and the diffusion plate 130″, and the produce may be kept in an optimally fresh state.

As described above, according to the present disclosure, it is possible to uniformly diffuse and irradiate LED light on the produce stored within the produce box. This makes it possible to maintain the produce stored within the produce box in an optimally fresh state for a long period of time and/or to improve the texture of the produce (e.g., mouth feel).

Although exemplary embodiments of the present disclosure are described with reference to the accompanying drawings, those skilled in the art will understand that the present disclosure may be implemented in various ways without changing the necessary features or the spirit of the present disclosure.

Therefore, it should be understood that the exemplary embodiments described above are not limiting, but only an example in all respects. The scope of the present disclosure is expressed by claims below, not the detailed description, and it should be construed that all changes and modifications achieved from the meanings and scope of claims and equivalent concepts are included in the scope of the present disclosure.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

What is claimed is:

1. A refrigerator comprising:
a refrigerator main body;
a cold air generation unit disposed within the refrigerator main body and configured to generate cold air within the refrigerator main body;
a produce storage unit disposed within the refrigerator main body and configured to accommodate a produce box; and
a lighting assembly configured to illuminate produce stored within the produce box with light,
wherein the lighting assembly comprises:
a light emitting body configured to irradiate the produce with light; and
a diffusion plate disposed on an inner wall of the produce box and configured to diffuse the light into an internal space of the produce box.

2. The refrigerator of claim 1, wherein the lighting assembly further comprises a mounting bracket to which the light emitting body is mounted, and wherein the mounting bracket comprises:
a mounting plate coupled to a guide shelf of the produce storage unit, wherein the mounting plate comprises a hole through which the light is transmitted; and
a plurality of support pieces protruding from the mounting plate to support the light emitting body.

3. The refrigerator of claim 1, wherein the produce storage unit comprises:
a guide shelf mounted to the refrigerator main body; and
an accommodation space disposed below the guide shelf and comprising a slanted surface inclined downward along an insertion direction of the produce box.

4. The refrigerator of claim 3, wherein the diffusion plate comprises:
a first reflection plate mounted to a first inner wall of the produce box and configured to receive light from the light emitting body and to reflect light from the light emitting body toward a second inner wall of the produce box, wherein the light emitting body is positioned close to the first inner wall; and
a second reflection plate mounted to the second inner wall of the produce box and configured to receive the light from the first reflection plate and to reflect the light toward a bottom portion of the produce box.

5. The refrigerator of claim 4, wherein the first and second diffusion plates distribute light uniformly into the produce box.

6. The refrigerator of claim 1, wherein the light emitting body irradiates the produce using substantially blue light to harden tissue of the produce.

7. The refrigerator of claim 1, wherein the light emitting body irradiates the produce using substantially red light to promote growth of the produce.

8. The refrigerator of claim 1, wherein the light emitting body irradiates the produce to improve a freshness or texture of the produce.

9. The refrigerator of claim 1, wherein the light emitting body comprises a light-emitting diode (LED) to irradiate the produce with LED light to preserve freshness of the produce.

10. A refrigerator, comprising:
a refrigerator main body;
a cold air generation unit configured to generate cold air within the refrigerator main body;
a produce storage unit configured to accommodate a removable produce box; and
a lighting assembly configured to illuminate produce stored within the produce box with light,
wherein the lighting assembly comprises:
a light emitting body configured to irradiate light;
a mounting bracket disposed in the produce storage unit and coupled to the light emitting body; and
a diffusion plate disposed on an inner wall of the produce box, wherein the diffusion plate comprises a curved surface for diffusing the light of the light emitting body into the produce box.

11. A lighting assembly for a refrigerator, the assembly comprising:
a light emitting body configured to irradiate light;
a mounting bracket disposed in a produce storage unit of the refrigerator and coupled to the light emitting body; and
a diffusion plate disposed on an inner wall of a produce box of the produce storage unit and configured to diffuse the light into the produce box.

12. The lighting assembly of claim 11, wherein the mounting bracket comprises:
a mounting plate disposed on a guide shelf of the produce storage unit and comprising a hole through which the light is transmitted; and
a plurality of support pieces protruding from the mounting plate to support the light emitting body.

13. The lighting assembly of claim 11, wherein the diffusion plate comprises a curved surface for diffusing the light of the light emitting body into the produce box.

14. The lighting assembly of claim 11, wherein the light emitting body emits substantially blue light to harden tissue of produce stored in the produce box.

15. The lighting assembly of claim 11, wherein the light emitting body emits substantially red light to promote growth of produce stored in the produce box.

16. The lighting assembly of claim 11, wherein the light emitting body irradiates produce stored in the produce box to improve a freshness or texture of the produce.
